(19) United States
(12) Patent Application Publication
(10) Pub. No.: US 2018/0333883 A1
(43) Pub. Date: Nov. 22, 2018

(54) RE-CUTTING DEVICE FOR WIPER BLADES

(71) Applicant: Harald Richter, Engelsbrand (DE)

(72) Inventor: Harald Richter, Engelsbrand (DE)

(21) Appl. No.: 15/801,660

(22) Filed: Nov. 2, 2017

(30) Foreign Application Priority Data
May 19, 2017 (DE) 20 2017002690.2

(51) Int. Cl. B26D 3/28; B08B 1/00; B26D 7/01; B26D 7/08

(52) U.S. Cl. CPC B26D 3/28; B08B 1/005; B60S 2001/3846; B26D 7/088; B26D 7/01

(57) ABSTRACT

A re-cutting device for wiper blades has a guide slot (2) conformed to the cross-sectional profile of the wiper blade (W) and having guide rails (2a) that engage with lateral grooves of the base of the wiper blade. A cutting blade (9) for re-cutting the wiper blade edge is arranged in an angled transverse position on a cutting block (7) that is displaceable in the transverse direction between at least two positions in a housing (1), wherein, in the at least two positions, the distance between the guide rails (2a) and the blade region of the cutting blade (9) respectively located in the guide slot region is of different size.

This application claims the priority of German Patent Application No. 20 2017 002 690.2, filed May 19, 2017, which is incorporated by reference herein in its entirety.

The invention relates to a device for the re-cutting of windscreen wiper blades when the edge of the wiper blade is worn out, in order to create a clean wiper blade edge by re-cutting the wiper blade, which makes it possible to wipe car windows free of streaking and smearing.

### BACKGROUND

The EP 2 580 032 B1 already has a tool for re-cutting worn out wiper blades for windscreen wipers, which has a guiding block with at least two parallel and laterally spaced guide slots, the clear cross-sectional profile of which corresponds to the cross-sectional profile of a wiper blade, wherein the guide slots each have guide rails on both sides which engage in the rear transverse grooves of the wiper blade on both sides. The guide rails of the at least two guide slots arranged next to each other respectively have a different distance to a cutting blade that is arranged in the profile tip area of the profile cross-section and is used for re-cutting the wiper edge so that a wiper blade can be re-cut at least twice.

Due to the arrangement of the guide slots next to each other, the guiding block of the tool is correspondingly wide, and its guiding along the wiper blade is somewhat difficult, because—if it is not possible to use the central guide slot, in the case of an embodiment corresponding to the exemplary embodiment in the citation having three guide slots—the wiper blade is always located off-center from the axis of motion of the device, and thus there will always be a tendency for tilting or canting during the cutting process, due to the thrust force acting off-set from the center too.

### SUMMARY

The object of the invention is therefore to create a smaller re-cutting device that is easier to handle, that always receives in a centered manner the wiper blade to be cut and that also allows to re-cut the wiper blade at least twice.

This object is achieved by the re-cutting device defined in claim 1. Advantageous embodiments of the invention are the subject matter of the dependent claims.

The re-cutting device according to the invention has only a single guide slot for receiving the wiper blade profile and can therefore have a correspondingly small total width. The wiper blade to be re-cut is always located centrally in the re-cutting device, as seen transversally to the direction of movement during the re-cutting process. The cutting blade is arranged on a cutting block that can be adjusted in the transverse direction between at least two positions in the device, so as to be adjustable between at least two positions having different distances between the cutting blade and the guide rails of the guide slot during the respective cutting process. Preferably, the cutting block can be locked in the least two positions. However, it is also possible to provide a continuously variable adjustment, for example by means of a setting screw.

### BRIEF DESCRIPTION OF THE DRAWINGS

In the following, an example embodiment of the invention will be described in more detail with reference to the accompanying drawings. In the drawings:

FIG. 1 shows the re-cutting device in a perspective view from the outside when cutting a wiper blade,

FIG. 2 shows a front view of the re-cutting device with a re-cut wiper blade,

FIG. 3 shows a cross section through the re-cutting device without wiper blade,

FIG. 4 shows a cross section through the re-cutting device, seen diagonally from behind, in an upside-down position,

FIGS. 5 and 6 show horizontal sections through the re-cutting device, seen from below, wherein FIG. 5 and FIG. 6 respectively show the cutting block in one and the other of the two cutting positions in the example embodiment, and

FIGS. 7 and 8 show perspective cross sections through the re-cutting device, respectively seen diagonally from the back, the sectioned cutting block again being shown in one or the other of the two possible positions.

### DETAILED DESCRIPTION

FIG. 1 shows the re-cutting device according to the invention in a perspective view, seen diagonally from the front, during the cutting of a wiper blade W. The re-cutting device has a housing 1 composed of two lateral housing halves 1a and 1b along a separating plane running in the longitudinal central plane. The lateral surfaces of the housing 1 having a slightly concave convex shape (clearly seen in FIG. 1) make the re-cutting device very easy to grip and thus very easy to handle.

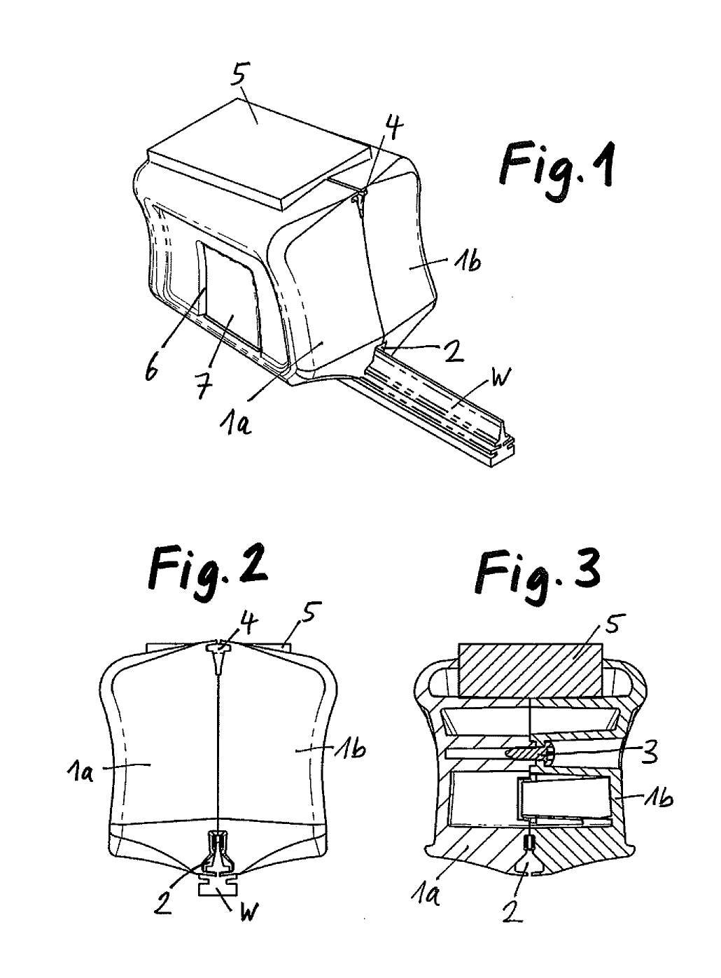

A guide slot 2 is formed in the middle of the housing at the bottom, the slot being adapted to the cross-sectional profile of the wiper blade W. This guide slot 2 is more clearly visible in the FIGS. 2 and 3, where FIG. 2 shows a front view of the re-cutting device including the wiper blade W. Here, it can be seen how the guide slot 2 receives the wiper blade and engages with guide rails 2a on both sides of the wiper blade W. FIG. 3 shows a cross section through the re-cutting device, also seen from the front, where the two halves 1a and 1b of the housing and their connection by screws 3 are clearly visible.

A cleaning groove 4 is formed at the top in the middle of the front area of the re-cutting device; behind the groove, a rectangular tray is formed in the upper side of the housing 1, into which a sponge 5 is inserted in a slightly clamped manner, so that it can be easily removed. Before re-cutting a wiper blade, it is pulled through the cleaning groove 4 to scrape off any dirt buildup adhering to the wiper blade, and the sponge 5 acts to clean the base of the wiper blade in particular.

In the perspective view according to FIG. 1, a transverse duct 6 in housing 1 can also be seen, in which a cutting block 7 is arranged so as to be displaceable in the transverse direction.

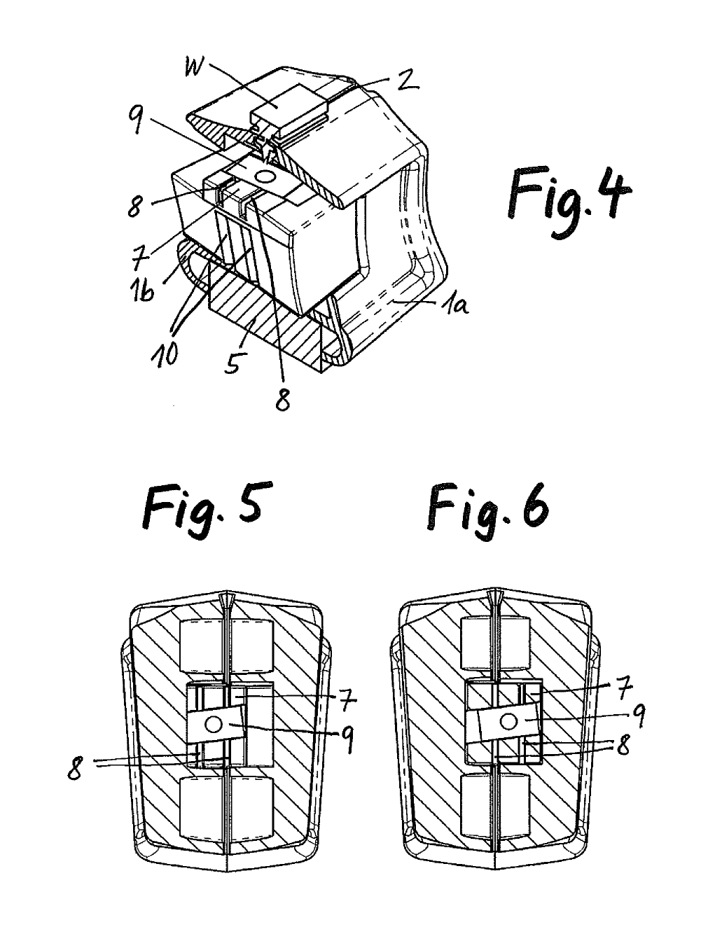

FIG. 5 shows a perspective cross-section of the re-cutting device shown in an upside-down position, seen diagonally from behind, wherein the section plane passes through the transverse duct 6 and shows the cutting block 7 (not shown in cross-section) therein. Thus, the sponge 5 located in a housing tray on the upper side is shown at the bottom here, and the wiper blade W is arranged at the top, in the guide slot 2.

In the example embodiment, the cutting block 7 that is displaceable in the transverse direction is provided between two defined lateral positions. It therefore has two parallel grooves 8 on its underside (shown at the top in FIG. 5), one groove 8 being aligned with the guide slot 2 in one position of the cutting block 7, and the other groove 8 being aligned with the slot in the other position of the cutting block 7, so that the wiper blade tip respectively can enter into the slot.

On the underside of the cutting block 7 (shown at the top in FIG. 5), a cutting blade 9 is arranged at an angle with respect to both the transverse direction and the height direction, and is preferably connected to the cutting block by means of ultrasonic welding. If the cutting block 7 is in its position shown in FIG. 5, the blade region of the cutting blade 9 that interacts with the wiper blade tip is spaced from the guide rails of the guide slot 2 by a shorter distance than in the other position of cutting block 7, which is slightly shifted to the right from the latter position and where this distance is somewhat larger. By means of the two cutting block positions provided in the example embodiment, it is thus possible to re-cut a wiper blade twice.

In a variation to the example embodiment shown here, it is also possible to provide three different positions of the cutting block 7 to enable the re-cutting three times.

In the example embodiment, provision is made for the cutting block 7 to be displaced between two defined positions. In order to ensure a defined positioning in each of these two positions, the cutting block has, as shown in FIG. 5, two vertically extending notches 10 that interact with a locking catch or a locking rail formed in the housing, so that the cutting block 7 can be locked in each of the two possible positions.

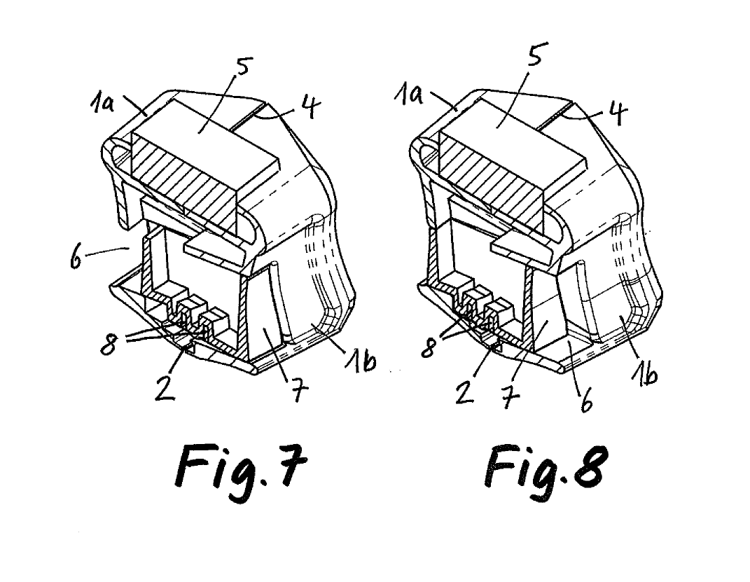

FIGS. 6 and 7 show horizontal sections through the re-cutting device seen from below, i. e. when looking at the underside of the cutting block 7, so that the grooves 8 in the cutting block and the cutting blade 9 located at the underside of the block can be seen clearly. Here, FIGS. 6 and 7 respectively show one of the two possible positions of the cutting block 7.

FIGS. 8 and 9 show, respectively seen diagonally from behind, cross sections of the re-cutting device, similar to FIG. 5, however not in the upside-down position, but instead in the correct position of the re-cutting device with the guide slot 2 at the bottom. FIGS. 8 and 9 also show the cutting block in section, respectively.

In a variation of the example embodiment having lockable positions of the cutting block, the cutting block can also be arranged in the transverse duct 6 so as to be displaceable in a continuously variable manner, for example by interaction between a screw nut fixed in the cutting block and a screw in the housing that is rotatable but axially fixed. In addition, other constructive variants of a stepped or continuously variable displacement of the cutting block in the transverse duct can also be provided.

It will be appreciated that the embodiments described above and shown in the drawings are merely exemplary in nature and that individual elements may also be combined differently than shown in these exemplary embodiments.

1. A re-cutting device for wiper blades comprising a guide slot with guide rails that is conformed to the cross-sectional profile of the wiper blade, the guide rails engaging with lateral grooves of the base of the wiper blade, and a cutting blade held in a defined distance from the guide rails for re-cutting the wiper blade edge,
wherein the cutting blade is arranged on a cutting block in an angled transverse position, the block being displaceable in the transverse direction between at least two positions in the housing, wherein, in the at least two positions, the distance between the guide rails and the blade region of the cutting blade respectively located in the guide slot region is of different size.

2. The re-cutting device according to claim 1, wherein the cutting block is displaceable in a transverse duct of the housing.

3. The re-cutting device according to claim 1, wherein the cutting block can be locked in its at least two positions.

4. The re-cutting device according to claim 1, wherein the cutting block is arranged in the housing in such a way that it can be displaced in the transverse direction by means of a screw spindle drive in a continuously variable manner.

5. The re-cutting device according to claim 1, wherein, in addition to the guide slot, a cleaning slot is formed in the housing, through which the wiper blade can be passed to scrape off any adhering dirt.

6. The re-cutting device according to claim 5, wherein the cleaning slot is arranged opposite the guide slot on the upper side of the housing.

7. The re-cutting device according to claim 1, wherein a trough for inserting a sponge is formed on the upper side of the housing.
